(19) United States
(12) Patent Application Publication
(10) Pub. No.: US 2026/0032468 A1
(43) Pub. Date: Jan. 29, 2026

(54) COMMUNICATION CONTROL METHOD

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/349,915

(22) Filed: Oct. 3, 2025

Related U.S. Application Data
(63) Continuation of application No. PCT/JP2024/014032, filed on Apr. 5, 2024.

(30) Foreign Application Priority Data
Apr. 6, 2023 (JP) 2023-062199

(51) Int. Cl. H04W 24/02; H04L 41/16

(52) U.S. Cl. CPC H04W 24/02; H04L 41/16

(57) ABSTRACT

The present disclosure relates to a communication control method in a mobile communication system. The communication control method includes transmitting, by a model transmission entity to a model reception entity, deletion prohibition information indicating whether deletion of an AI/ML model is prohibited and/or deletion condition information indicating a deletion condition for the AI/ML model.

### RELATED APPLICATIONS

The present application is a continuation based on PCT Application No. PCT/JP2024/014032, filed on Apr. 5, 2024, which claims the benefit of Japanese Patent Application No. 2023-062199 filed on Apr. 6, 2023. The content of which is incorporated by reference herein in their entirety.

### TECHNICAL FIELD

The present disclosure relates to a communication control method.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: 3GPP Contribution RP-213599, “New SI. Study on Artificial Intelligence (AI)/Machine Learning (ML) for NR Air Interface”

### SUMMARY

In an aspect, a communication control method is a communication control method in a mobile communication system. The communication control method includes transmitting, by a model transmission entity to a model reception entity, deletion prohibition information indicating whether deletion of an AI/ML model is prohibited and/or deletion condition information indicating a deletion condition for the AI/ML model.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an example of reducing CSI-RSs according to the first embodiment.

FIG. 10 is a diagram illustrating an example of reducing the CSI-RSs according to the first embodiment.

FIG. 11 is a diagram illustrating an operation example according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an arrangement example of functional blocks of the AI/ML technology according to the first embodiment.

FIG. 15 is a diagram illustrating an operation example according to the first embodiment.

FIG. 16 is a diagram illustrating an arrangement example of functional blocks of the AI/ML technology according to the first embodiment.

FIG. 17 is a diagram illustrating an operation example according to the first embodiment.

FIG. 18 is a diagram illustrating an operation example according to the first embodiment.

FIG. 19 is a diagram illustrating an example of a configuration message according to the first embodiment.

FIG. 20 is a diagram illustrating a configuration example of a mobile communication system according to the first embodiment.

FIG. 21 is a diagram illustrating an operation example according to the first embodiment.

FIGS. 22A and 22B are diagrams illustrating configuration examples of a mobile communication system according to a second embodiment.

FIG. 23 is a diagram illustrating a configuration example of the mobile communication system according to the second embodiment.

FIG. 24 is a diagram illustrating an operation example according to the second embodiment.

FIG. 25 is a diagram illustrating an operation example according to a third embodiment.

FIG. 26 is a diagram illustrating an example of a relationship between a model and model data according to a fourth embodiment.

FIG. 27 is a diagram illustrating an operation example according to the fourth embodiment.

### DESCRIPTION OF EMBODIMENTS

An object of the present disclosure is to enable a user equipment to appropriately delete an AI/ML model.

### First Embodiment

A mobile communication system according to a first embodiment will be described with reference to the drawings. In the description of the drawings, the same or similar parts are denoted by the same or similar reference signs.

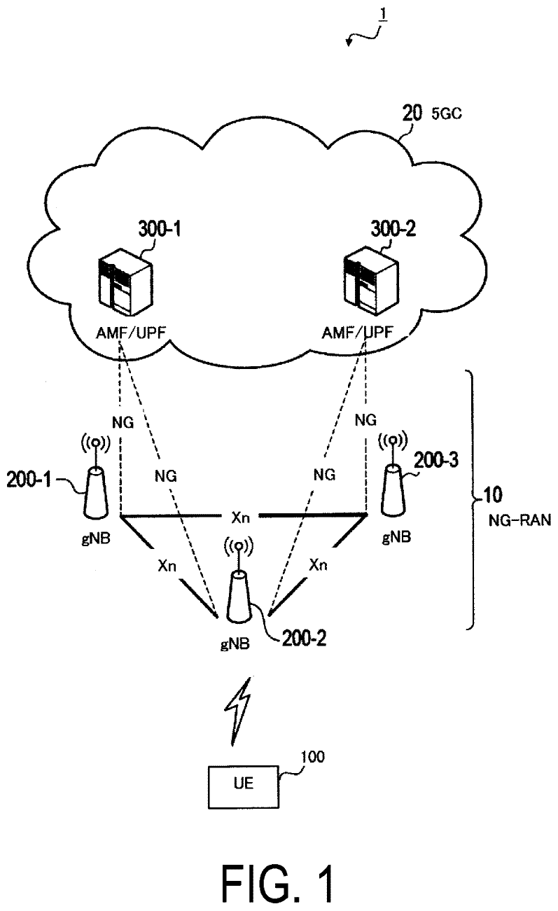

Configuration of Mobile Communication System A configuration of a mobile communication system according to a first embodiment will be described. FIG. 1 is a diagram illustrating a configuration example of the mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

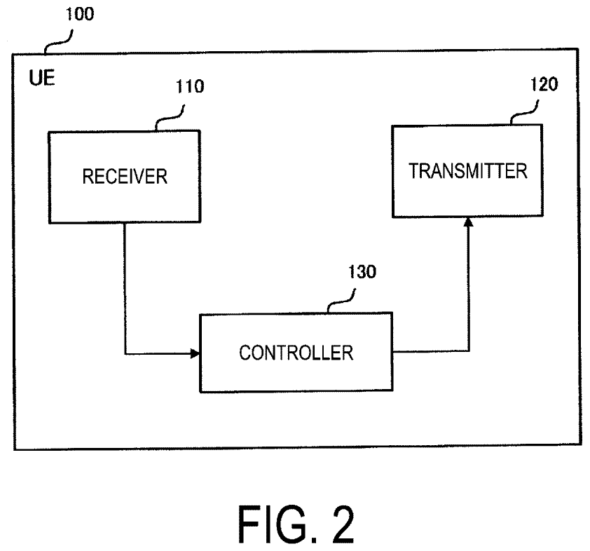

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

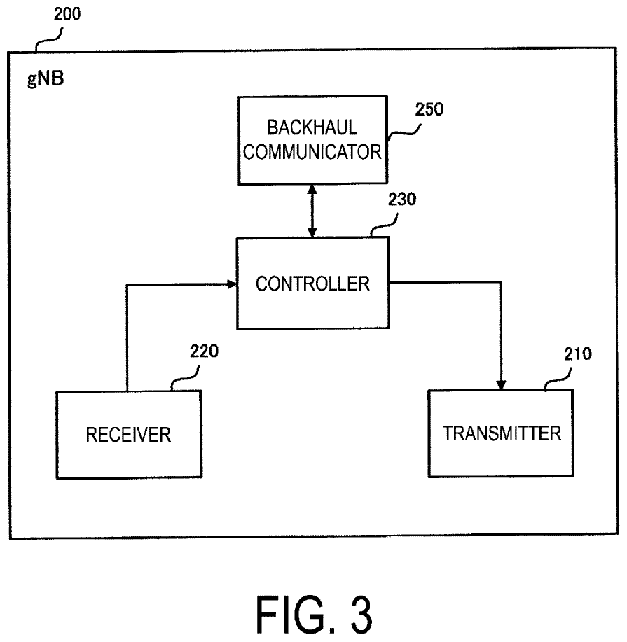

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

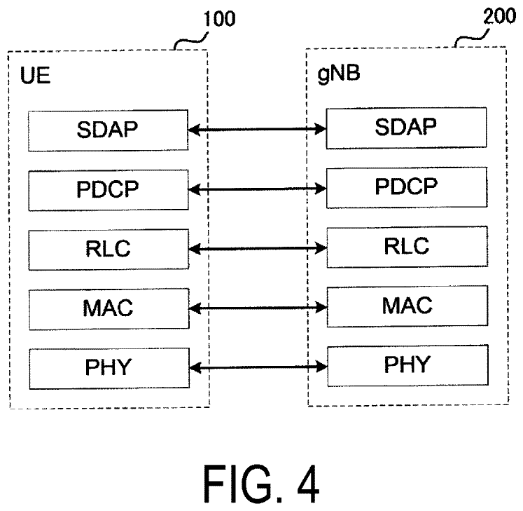

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic redundancy code (CRC) parity bits scrambled by the RNTI are added to the DCI transmitted from the gNB 200.

In NR, the UE 100 can use a bandwidth narrower than a system bandwidth (i.e., a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the receiving side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

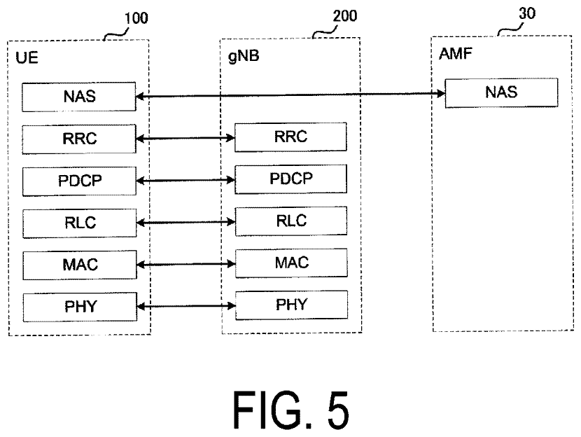

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer and the like other than the protocol of the radio interface. Further, a layer lower than the NAS is referred to as an access stratum (AS).

### AI/ML Technology

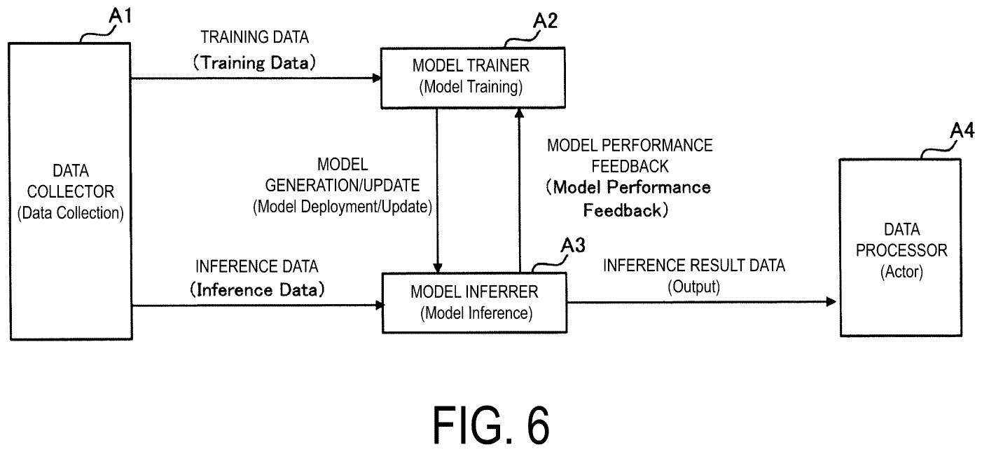

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to a process of collecting data at a network node, a management entity, or the UE 100, for example, in order to perform training, data analysis, and inference of the AI/ML model. Based on the data collected by the data collector A1, the training of the AI/ML model and the inference of the AI/ML model in the subsequent stage are performed. The “AI/NL model” is, for example, a data-driven algorithm to which an AI/ML technology is applied to generate a series of outputs based on a series of inputs. Hereinafter, “model” and “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning. Thus, a process of training the AI/ML model (by learning a relationship between the input and the output) in a data driven manner to acquire a trained AI/ML model is referred to as, for example, AI/ML model training. Hereinafter, the “AI/ML model training” may be referred to as a “model training”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. The process of generating a series of outputs based on a series of inputs using the trained AI/ML model in this manner is referred to as AI/ML model inference. Hereinafter, the “AI/ML model inference” may be referred to as “model inference”.

The data processor A4 receives the inference result data and performs processing that utilizes the inference result data.

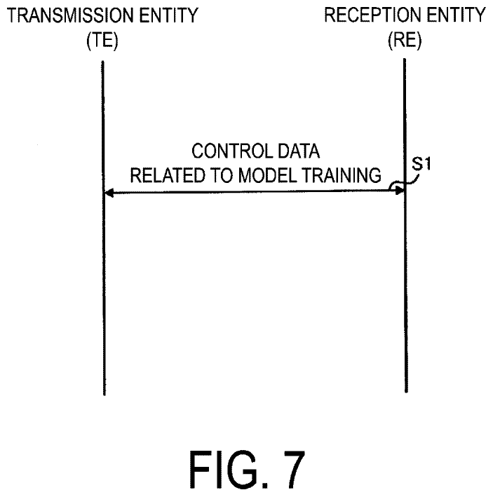

FIG. 7 is a diagram illustrating an operation example in the AI/ML technology according to the first embodiment.

A transmission entity TE is, for example, an entity in which machine learning is performed. The transmission entity TE derives a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The transmission entity TE performs various processing operations by using the inference result data received from the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in a step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (for example, an AI/ML layer) dedicated to artificial intelligence or machine learning.

Arrangement Examples and Use Cases How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement” Hereinafter, an arrangement example of the functional blocks will be described for each use case.

### (1.1) Arrangement Example of Functional Blocks in “CSI Feedback Enhancement”

The “CSI feedback enhancement” represents, for example, a use case in which the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

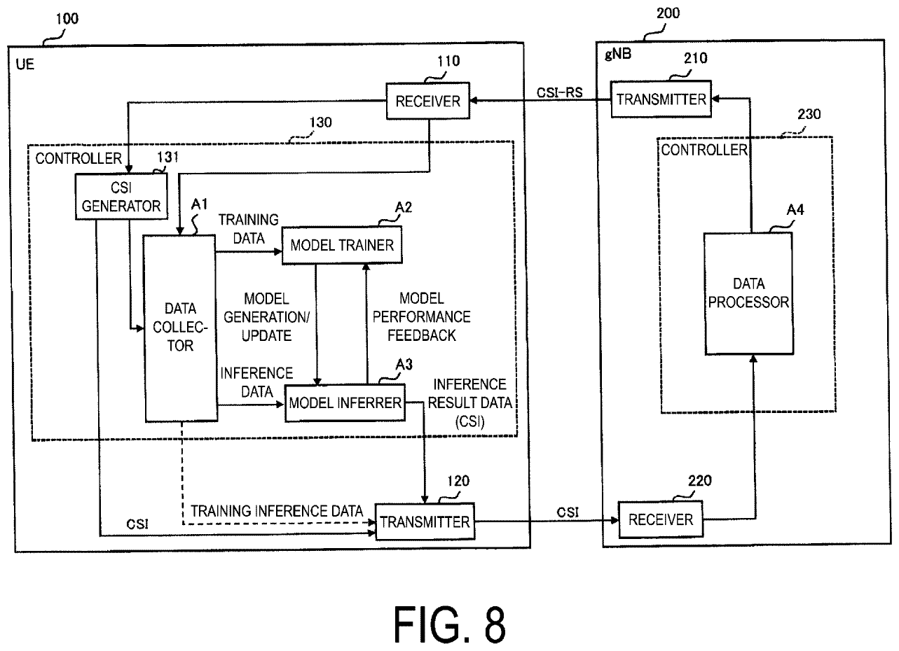

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, the CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

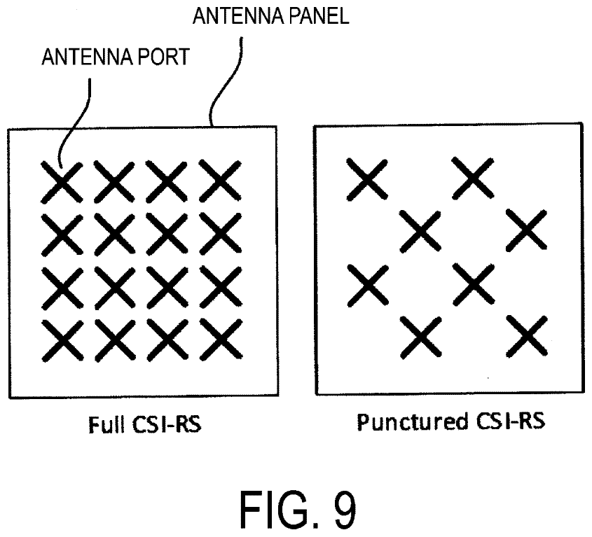

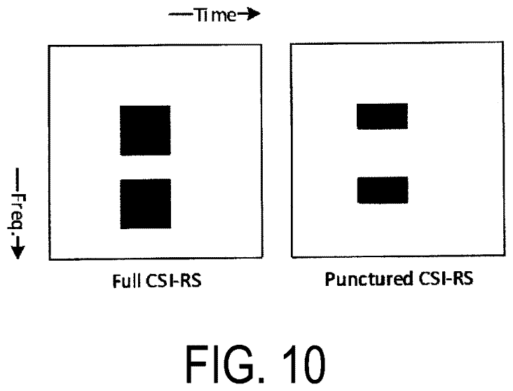

FIGS. 9 and 10 are diagrams illustrating an example of reducing CSI-RSs according to the first embodiment.

FIG. 9 illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 10 illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9 and 10, the gNB 200 transmits the full CSI-RS using a predetermined amount of first resources, and transmits the partial CSI-RS using second resources that are less than the first resources.

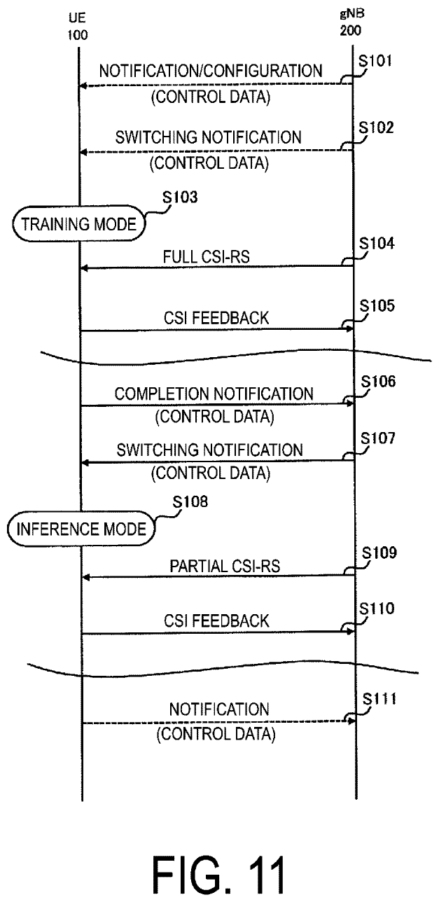

FIG. 11 illustrates an operation example in the “CSI feedback enhancement” according to the first embodiment.

As illustrated in FIG. 11, in step S101, the gNB 200 may notify the UE 100 of or configure for the UE, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching information notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back) the CSI, which is an inference result, to the gNB 200 as inference result data. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 11, the training data is “(full) CSI-RS” and “CSI”, and the inference data is “(partial) CSI-RS”. Hereinafter, the training data and/or the inference data may be referred to as a “dataset”.

In the “CSI feedback enhancement”, for example, at least one selected from the group consisting of the following data or information may be used as the dataset in addition to the “CSI-RS” and the “CSI”.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100) What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits the data type information used as a dataset, to the UE 100 as the control data. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case in which the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

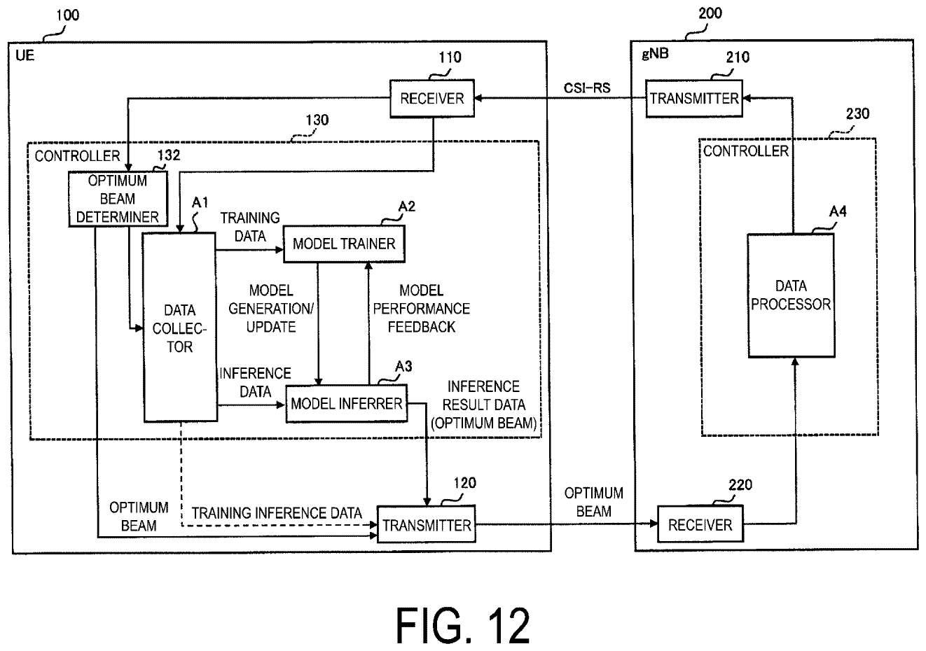

FIG. 12 is a diagram illustrating an arrangement example of the functional blocks in the “beam management”. In the example of the “beam management” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 performs model training and model inference. FIG. 12 illustrates the example in which the transmission entity TE is the UE 100 and the reception entity RE is the gNB 200.

As illustrated in FIG. 12, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 11.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, at least one selected from the group consisting of the following data or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER ((BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100) The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit the data type information used as a dataset, to the UE 100 as the control data. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case in which the accuracy of the position information measured by the UE 100 is enhanced using the machine learning technology.

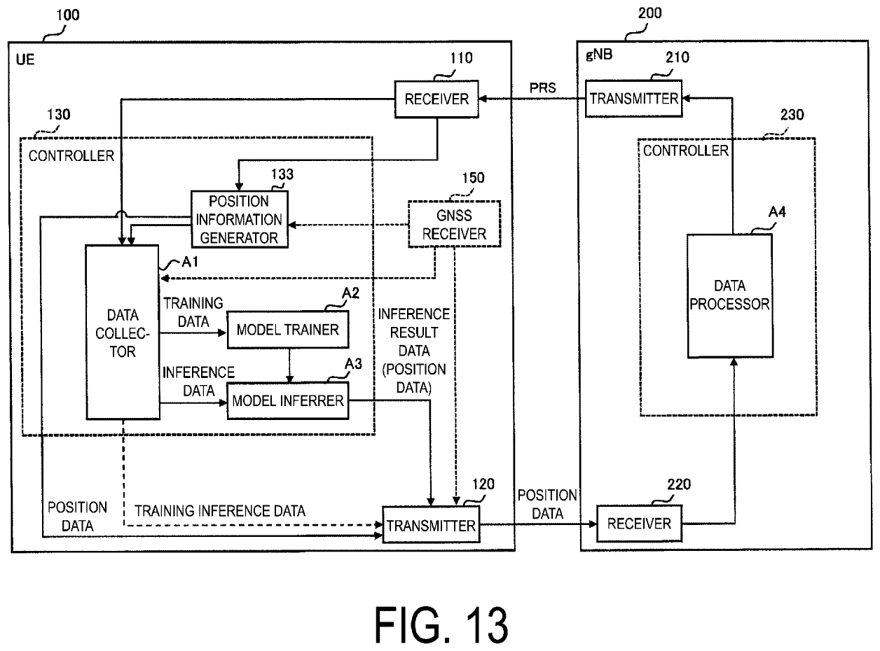

FIG. 13 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model trainer A2, and the model inferrer A3. On the other hand, the controller 230 of the gNB 200 includes the data processor A4. In other words, FIG. 13 illustrates an example in which the UE 100 performs model training and model inference. FIG. 13 illustrates an example in which the transmission entity TE is the UE 100 and the reception entity RE is the gNB 200.

As illustrated in FIG. 13, the UE 100 includes a position information generator 133. The UE 100 may include a Global Navigation Satellite System (GNSS) reception device 150. The position information generator 133 generates position data of the UE 100 based on a Positioning Reference Signal (PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports as illustrated in FIG. 9 or a predetermined amount of time frequency resources as illustrated in FIG. 10). Further, as with the partial CSI-RS, the gNB 200 transmits the partial PRS by using the second resource (for example, half the antenna ports in the antenna panel as illustrated in FIG. 9, or half the predetermined number of time-frequency resources as illustrated in FIG. 10) having the smaller number of resources than the first resources.

Further, the full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “position accuracy improvement” can be implemented by replacing the “full CSI-RS” with the “full PRS”, the “partial CSI-RS” with the “partial PRS”, and the “CSI feedback” with the “position data” in FIG. 11.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, at least one selected from the group consisting of the following data or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(Z7) Moving speed of the UE 100 (the moving speed may be measured by the GNSS reception device 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit the data type information used as a dataset, to the UE 100 as the control data. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

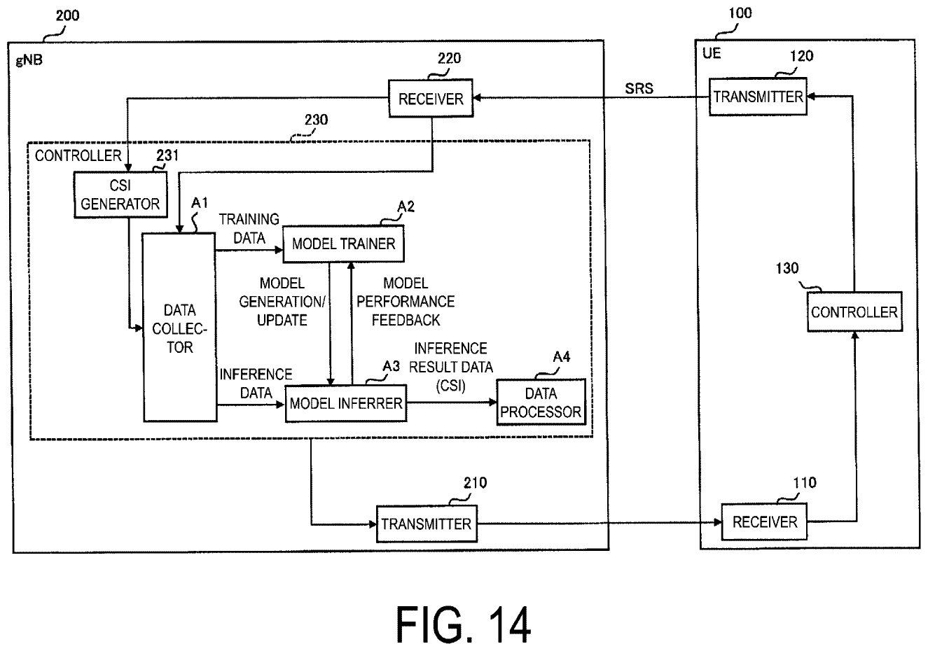

FIG. 14 is a diagram illustrating another arrangement example of the “CSI feedback enhancement” according to the first embodiment. FIG. 14 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 14 illustrates an example in which the transmission entity TE is the gNB 200 and the reception entity RE is the UE 100.

FIG. 14 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (for example, the data processor A4) performs, for example, uplink scheduling based on the CSI generated based on the SRS.

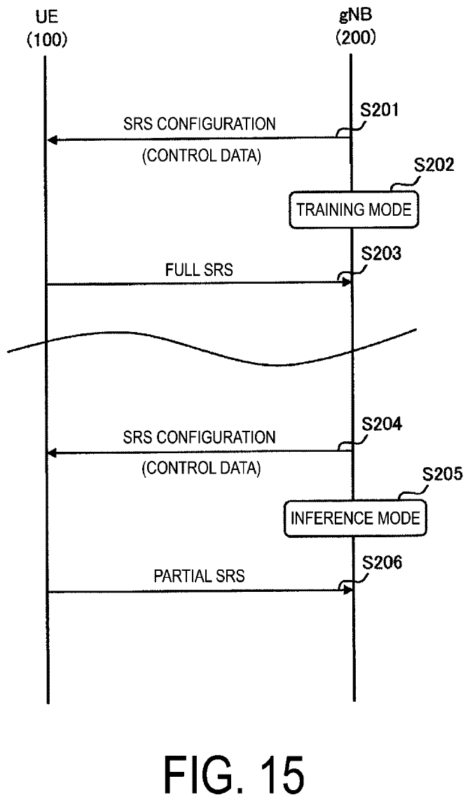

FIG. 15 is a diagram illustrating an operation example in another arrangement example according to the first embodiment.

As illustrated in FIG. 15, in step S201, the gNB 200 provides SRS configuration for the UE 100. The SRS transmission configuration may include type information of the reference signal transmitted by the UE 100.

In step S202, the gNB 200 starts the training mode.

In step S203, the UE 100 transmits a full SRS to the gNB 200 in accordance with the SRS transmission configuration (step S201). The receiver 220 of the gNB 200 receives the full SRS. In the training mode, the CSI generator 231 generates (or estimates) CSI based on the full SRS. The data collector A1 collects the full SRS and the CSI. The model trainer A2 uses the full SRS and the CSI as training data to generate a trained model.

In step S204, the gNB 200 specifies the transmission pattern (puncture pattern) of the SRS to be input to the trained model as the inference data, and configures the specified SRS transmission pattern for the UE 100. The gNB 200 may transmit, to the gNB 200, the SRS transmission configuration including the specified SRS transmission pattern.

In step S205, the gNB 200 switches from the training mode to the inference mode. The gNB 200 starts the model inference using the trained model.

In step S206, the UE 100 transmits the partial SRS in accordance with the SRS transmission configuration (step S204). When the gNB 200 inputs the SRS as the inference data to the trained model to obtain a channel estimation result, the gNB 200 performs uplink scheduling (for example, control of uplink transmission weights and the like) of the UE 100 by using the channel estimation result. Note that when the inference accuracy achieved by the trained model deteriorates, the gNB 200 may reconfigure the UE 100 to cause the UE 100 to transmit the full SRS.

(1.5) Arrangement Example when Federated Learning is Performed

An arrangement example of the functional blocks used when federated learning is performed will be described. The federated learning is, for example, one approach for machine learning in which machine learning is performed in a state where data (or a dataset) is not aggregated but distributed. In the federated learning, each entity does not need to transmit data, and thus the security of the entity can be ensured. The federated learning is considered to be able to obtain a training result with accuracy equivalent to that of the conventional centralized machine learning.

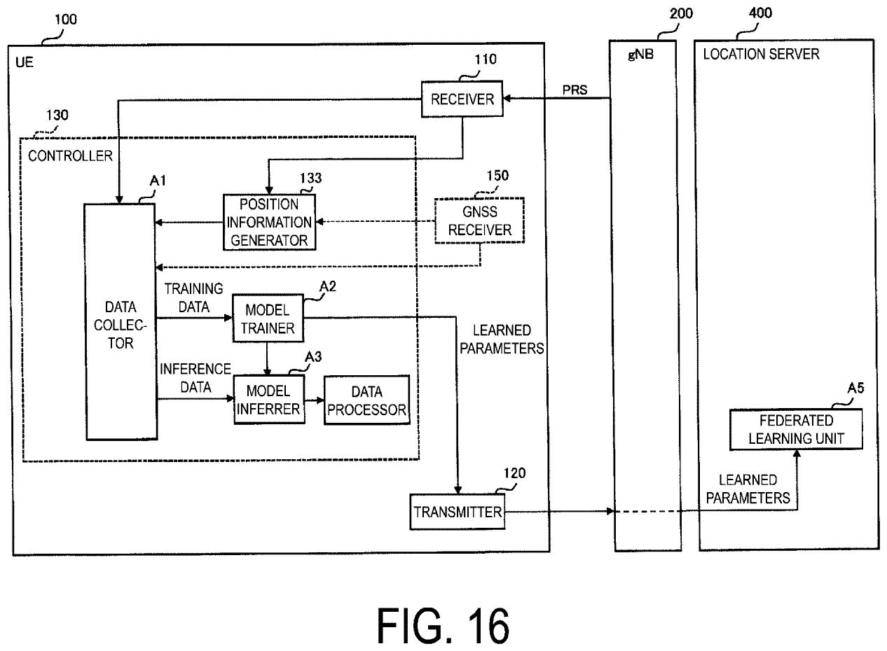

FIG. 16 is a diagram illustrating an arrangement example in which the federated learning according to the first embodiment is performed. The example illustrated in FIG. 16 illustrates an example of a case in which the position estimation of the UE 100 is performed using the federated learning. FIG. 16 illustrates an example in which the UE 100 includes the data collector A1, the model trainer A2, and the model inferrer A3. In other words, FIG. 16 illustrates an example in which the UE 100 performs model training and model inference. FIG. 16 illustrates an example in which the UE 100 is the transmission entity TE and the gNB 200 and/or a location server 400 is the reception entity RE.

The federated learning illustrated in FIG. 16 is performed in the following procedure, for example.

First, the location server 400 transmits, to the UE 100, the model on which model training is based.

Second, the UE 100 (model trainer A2) performs model training using the data present in the UE 100. The data present in the UE 100 may be, for example, a PRS received from the gNB 200 and/or output data (GNSS signal) from the GNSS reception device 150. The data present in the UE 100 may include position data generated by the position information generator 133 based on the reception result of the PRS and/or the output data from the GNSS reception device 150.

Third, the UE 100 applies the trained model, which is the training result, to the model inferrer A3 and transmits, to the location server 400, variable parameters included in the trained model (hereinafter also referred to as “learned parameters”). In the above example, the optimized a (slope) and b (intercept) correspond to the learned parameters.

Fourth, the location server 400 (federated learning unit A5) collects the learned parameters from a plurality of UEs 100 and integrates these parameters. The location server 400 may transmit, to the UE 100, the trained model obtained by the integration. The location server 400 can estimate the position of the UE 100 based on the trained model and a measurement report from the UE 100.

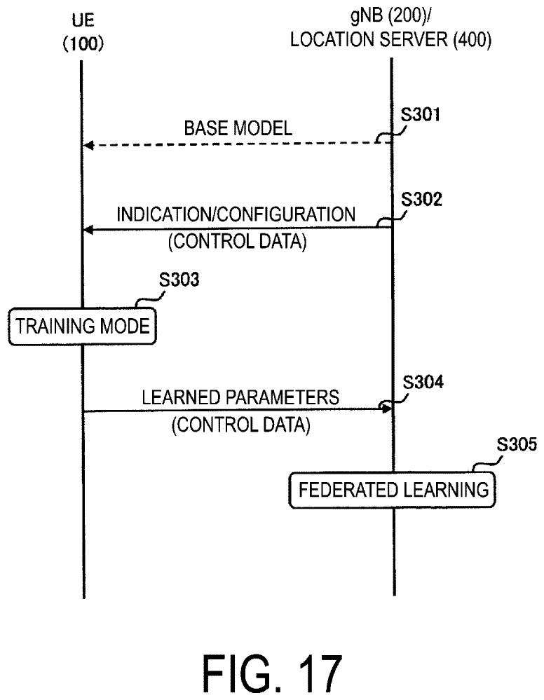

FIG. 17 is a diagram illustrating an operation example in the federated learning according to the first embodiment.

As illustrated in FIG. 17, in step S301, the gNB 200 may notify the UE 100 of a model on which learning of the UE 100 is based. The location server 400 may notify the UE of the model via the gNB 200.

In step S302, the gNB 200 indicates the UE 100 about model training. The gNB 200 may configure a report timing (trigger condition) of the learned parameters. The report timing may be a periodic timing. The report timing may be a timing triggered by learning proficiency satisfying a condition (i.e., an event trigger).

In step S303, the UE 100 starts the training mode. The UE 100 performs model training using, as the training data, the full PRS (or the full GNSS signal) and the position data generated by the position information generator 133.

In step S304, when the condition of the report timing is satisfied, the UE 100 transmits, to the network (gNB 200 or location server 400) the learned parameters obtained at that time.

In step S305, the location server 400 integrates the learned parameters reported from a plurality of UEs 100.

### (1.6) Model Transfer Example

In (1.1) to (1.5), the arrangement example of the functional blocks of the AI/ML technology has been described. A model transfer example will be described below. The model to be transferred may be a trained model used in the model inference. The model may be an untrained model used in the model training (or a model being trained).

### (1.6.1) First Operation Pattern Relating to Model Transfer

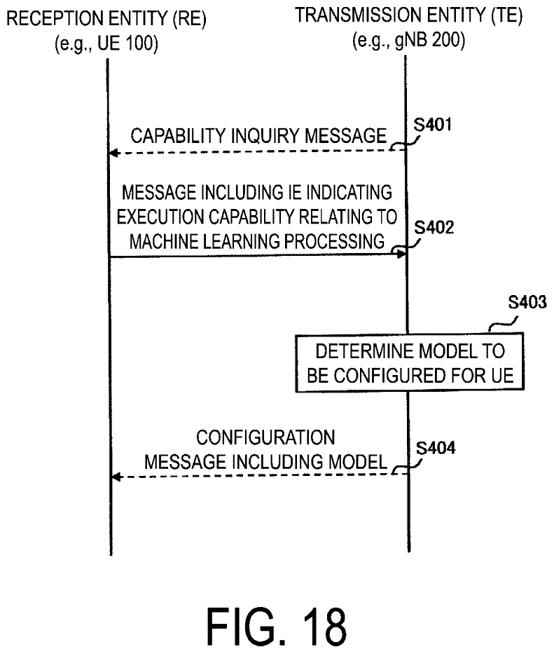

FIG. 18 is a diagram illustrating an operation example of a first operation pattern relating to model transfer according to the first embodiment. In the example illustrated in FIG. 18, the reception entity RE is mainly described as the UE 100. However, the reception entity RE may be the gNB 200 or AMF 300. In the example illustrated in FIG. 18, the transmission entity TE is mainly described as the gNB 200. However, the transmission entity TE may be the UE 100 or AMF 300.

As illustrated in FIG. 18, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (for example, a “UE AI Capability” message or the like). Alternatively, the transmission entity TE may be the AMF 300 and the message may be a NAS message. When a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may indicate the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may indicate the processing capacity of the learning processing.

In step S403, the gNB 200 determines a model to be configured (or deployed) for the UE 100 based on the information element included in the message received in step S402.

In step S404, the gNB 200 transmits, to the UE 100, a message including the model determined in step S403. The UE 100 receives the message and performs the machine learning processing (i.e., model training processing and/or model inference processing) using the model included in the message. A specific example of step S404 will be described in a second operation pattern below.

### (1.6.2) Second Operation Pattern Relating to Model Transfer

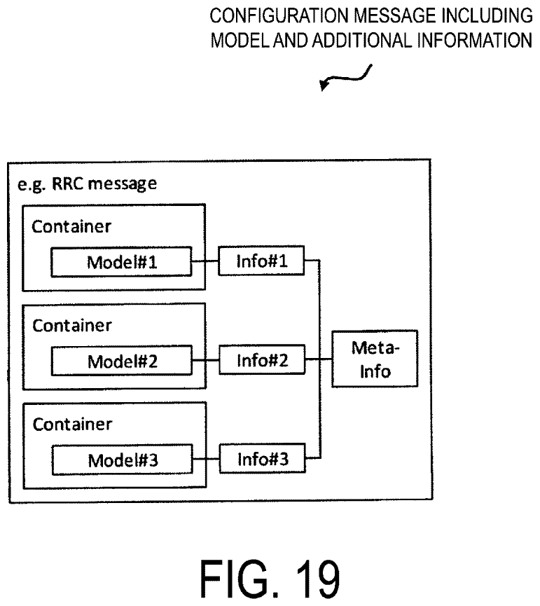

FIG. 19 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (2) Communication Control Method According to First Embodiment

A communication control method according to the first embodiment will be described.

In the UE 100, an untrained model may be held in a memory when model learning is performed. In addition, in the UE 100, a trained model may be held in the memory when model inference is performed.

However, a memory capacity of the UE 100 is finite. It may not always be efficient to store all models in the memory in the UE 100. For example, in a use case of “position accuracy enhancement”, a trained model trained in a certain region may not be suitable in another region. Further, for example, a trained model stored in the memory in the past may not be suitable now. Therefore, in the UE 100, it may be more efficient to delete the model.

However, when the UE 100 deletes the model at its own discretion, it may not necessarily be preferable on the network side. For example, in a case where the UE 100 does not hold a specific trained model regardless of the network side instructing the UE 100 to use the specific trained model, the network side may need to perform extra processing such as transmitting the trained model to the UE 100.

Therefore, the first embodiment aims to allow the UE 100 to delete the AI/ML model appropriately.

To this end, in the first embodiment, the model transmission entity (for example, the gNB 200) transmits to the model reception entity (for example, the UE 100) deletion prohibition information indicating whether deletion of the AI/ML model is prohibited and/or deletion condition information indicating a deletion condition for the AI/ML model.

Accordingly, for example, the UE 100 can delete the AI/ML model in accordance with the deletion prohibition information and/or the deletion condition information transmitted from the network side (for example, the gNB 200). Therefore, the UE 100 will no longer delete the AI/ML model at its own discretion, and can delete the AI/ML model in accordance with an instruction from the network side, and thus it is possible for the UE 100 to appropriately delete the AI/ML model.

Here, the model transmission entity MTE refers to, for example, an entity that transmits the AI/ML model. The AI/ML model may be an untrained model or a trained model. The model transmission entity MTE is, for example, the gNB 200. The model transmission entity MTE may also be a core network device.

On the other hand, the model reception entity MRE refers to, for example, an entity that receives the AI/ML model. The model reception entity MRE receives the AI/ML model transmitted from the model transmission entity MTE. The model reception entity MRE is, for example, the UE 100.

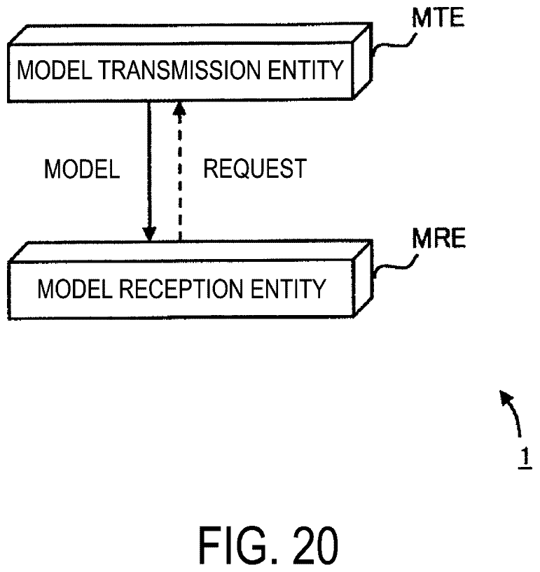

FIG. 20 is a diagram illustrating a configuration example of a mobile communication system 1 according to the first embodiment. As illustrated in FIG. 20, the mobile communication system includes the model transmission entity MTE and the model reception entity MRE.

When the model transmission entity MTE is the gNB 200, for example, the model transmission entity MTE may transmit the model by transmitting an RRC message including the model to the model reception entity MRE. Also, when the model transmission entity MTE is a core network device (for example, the AMF 300), the model transmission entity MTE may transmit the model by transmitting a predetermined message (for example, a NAS message) including the model to the model reception entity MRE.

As illustrated in FIG. 20, the model reception entity MRE may transmit request information for requesting transfer of the model to the model transmission entity MTE. The model transmission entity MTE may transmit the model in response to the model request information. When the model transmission entity MTE is the gNB 200, the model request information may be included and transmitted in control data. When the model transmission entity MTE is a core network device (for example, the AMF 300), the model request information may be included in a predetermined message (for example, a NAS message) and transmitted.

In the first embodiment, an example in which the model transmission entity MTE includes the deletion prohibition information and/or the deletion condition information in the model will be described. Specifically, this is an example in which the model transmission entity MTE (for example, the gNB 200) transmits an AI/ML model including the deletion prohibition information and/or the deletion condition information to the model reception entity MRE (for example, the UE 100).

### Deletion Prohibition Information and Deletion Condition Information

Here, specific examples of the deletion prohibition information and the deletion condition information will be described.

The deletion prohibition information is, for example, information indicating whether deletion of the AI/ML model is prohibited, as described above.

First, the deletion prohibition information may be information indicating that deletion is prohibited. For example, when the model includes the deletion prohibition information indicating that deletion is prohibited, this indicates that the deletion of the model is prohibited, that is, that there is no need to delete the model.

Second, the deletion prohibition information may be information indicating that deletion is permitted. For example, when the model includes the deletion prohibition information indicating that deletion of the model is permitted, this indicates that the model may be deleted or may not be deleted.

Third, the deletion prohibition information may be information indicating that deletion is permitted, provided that the deletion condition is satisfied. For example, when the model includes the deletion prohibition information, this indicates that the model may be deleted or may not be deleted, provided that the deletion condition is satisfied. In this case, the model also includes deletion condition information together with the deletion prohibition information.

Fourth, the deletion prohibition information may be information indicating that the model needs to be forcibly deleted, provided that the deletion condition is satisfied. For example, when the model includes the deletion prohibition information, this indicates that the model is forcibly deleted, provided that the deletion condition is satisfied. In this case, the model also includes deletion condition information together with the deletion prohibition information.

On the other hand, the deletion condition is, for example, as shown in the following table.

TABLE 1

| Deletion condition | Application example |
|---|---|
| Time, timing, | Time: This indicates an expiration date. This indicates that, for |
| or use | example, when the deletion condition is “2023 June”, the model is |
| frequency | available until May 2023, and is not available after June 2023 and |
| | deletion is permitted (or conversely the model may be deleted until |
| | June 2023). |
| | Use frequency: This indicates that, for example, when the use |
| | frequency is “7 days”, deletion of a model that has not been used for 7 |
| | days or more is permitted (or vice versa). |
| | The time or timing may be determined by a period in which the model |
| | is activated or a period in which the model is deactivated. |
| | The time, timing, or use frequency may be indicated by a range. In this |
| | case, this may indicate that the deletion is permitted within the range |
| | (or, conversely, the deletion may be permitted when the range is |
| | exceeded). |
| Place, position, | The deletion condition may be indicated by GPS location information, |
| or affiliation | a place name, a cell name (or cell ID), a tracking area information |
| | (TAI), a registration area (RA), or a public land mobile network |
| | number (PLMN). For example, when the deletion condition is “TA |
| | #1”, the deletion is permitted when moving away from TA #1 (or |
| | conversely, the deletion may be permitted within TA #1). The deletion |
| | condition may be indicated by a place, a position, or a range of |
| | affiliation, and in this case, the deletion may be permitted within the |
| | range (or outside the range). |
| Moving speed | This indicates a moving speed of the object (for example, the UE 100). |
| | This may indicate that, in the case of “40 km” as the deletion condition, |
| | the deletion is permitted when a moving speed becomes equal to or |
| | lower than 40 km (or equal to or higher than 40 km) (for a model |
| | dedicated to a high-speed moving train). The moving speed may be |
| | indicated by a range, and in this case, this may indicate that the |
| | deletion is permitted within (or outside) the range. |
| Altitude | This indicates an altitude of an object (for example, the UE 100). The |
| | altitude may represent a height from the ground or may represent a |
| | height from a sea level of 0 m. This indicates that, in the case of |
| | “altitude 0 m” as the deletion condition, when the altitude becomes “0 |
| | m”, that is, after landing, the deletion is permitted (or the deletion is |
| | prohibited) (for a model dedicated to the time of aircraft movement). |
| | The altitude may be indicated by a range, and this may indicate that |
| | the deletion can be performed within (or outside) the range. |
| Computing resource | This indicates a remaining memory capacity. When the memory |
| | capacity becomes equal to or less than the remaining memory capacity |
| | (or less than the memory capacity), this may indicate that the deletion |
| | is permitted. |
| Slice information | This indicates a slice that is a deletion target. The slice information is |
| | represented by, for example, a Network Slice AS Group (NASG), |
| | Network Slice Selection Assistance Information (NSSAI), or Single- |
| | Network Slice Selection Assistance Information (S-NSSAI). For |
| | example, when the UE 100 uses a model by using the slice indicated |
| | by the slice information, this indicates that the model may be deleted. |

A case where the deletion condition is not satisfied may indicate a use condition of the model. Alternatively, a case where the use condition is not satisfied may indicate the deletion condition. The deletion condition and the use condition may have an inverse relationship with each other (for example, a relationship in which when one is satisfied, the other is not satisfied, and when the other is satisfied, the one is not satisfied).

The deletion prohibition information and/or the deletion condition information may be referred to as “deletion information” hereinafter.

### Operation Example According to First Embodiment

Next, an operation example according to the first embodiment will be described.

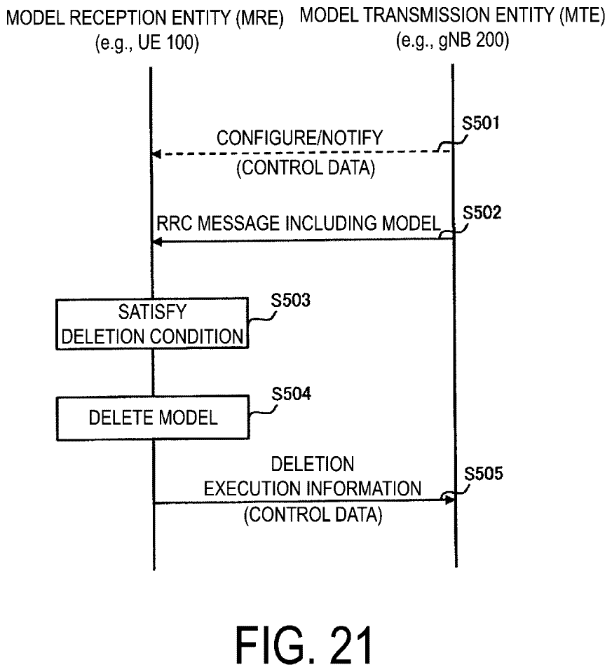

FIG. 21 is a diagram illustrating an operation example according to the first embodiment. As illustrated in FIG. 21, an example in which the model transmission entity MTE is the gNB 200 and the model reception entity MRE is the UE 100 will be described.

In step S501, the gNB 200 uses control data to perform configuration or notification for the UE 100. The gNB 200 may configure or notify the UE 100 of switching to an inference mode. The gNB 200 may also perform configuration or notification of puncture pattern or the like used in “CSI feedback” or the like.

In step S502, the gNB 200 includes the deletion information in the model and transmits the model including the deletion information to the UE 100 using an RRC message.

The gNB 200 includes the deletion information in the model. Specifically, the deletion information may be included in file data including the model. For example, when the model itself is included in the file data, the gNB 200 includes the deletion information in the file data. Alternatively, the deletion information may be added to a model ID that identifies the model. For example, the gNB 200 may add the deletion information to the model ID, include the model ID including the deletion information in individual additional information (FIG. 19) (or include the model ID as the individual additional information), and transmit the individual additional information to the UE 100. Alternatively, the deletion information may be included in meta information of the model. For example, the gNB 200 may include the meta information including the deletion information in the common additional information (Meta-Info) (FIG. 19) (or include the meta information as the common additional information) and transmit the common additional information to the UE 100.

In step S503, the UE 100 enters a state in which the deletion condition is satisfied. The UE 100 may notify the gNB 200 that the UE 100 has entered the state in which the deletion condition is satisfied (or that the UE 100 desires the execution). The notification may include any one of a model identifier for identifying the model, a deletion condition identifier for identifying the deletion condition, information indicating the deletion condition that has been satisfied, or information indicating the condition (cause). The notification may be transmitted when the deletion condition is satisfied. The notification may be transmitted using control data. When the gNB 200 receives the notification and accepts deletion of the model, the gNB 200 may transmit a model deletion command to the UE 100. The model deletion command may also be transmitted using control data.

In step S504, the UE 100 deletes the model. The UE 100 confirms that the deletion condition included in the model is satisfied (step S503), and deletes the model. When the model does not include the deletion condition but includes the deletion prohibition information, the UE 100 may delete the model in accordance with the deletion prohibition information, regardless of whether the deletion condition is satisfied. The UE 100 may confirm an available capacity of the memory and delete the model when the available capacity falls below a capacity threshold.

The deletion information may be hard-coded. In this case, the deletion information is not transmitted from the gNB 200, and for example, the UE 100 may delete the model in accordance with the deletion condition defined in the specification.

In step S505, the UE 100 transmits deletion execution information indicating that the model has been deleted to the gNB 200. In this case, the UE 100 may transmit information for specifying the deleted model to the gNB 200. The information may be specified by a model ID, model name, or model identification information. The information may be included in the deletion execution information. In subsequent embodiments, transmission of the information for specifying the deleted model is similarly performed when the deletion execution information is transmitted. The UE 100 may transmit the deletion execution information to the gNB 200 as control data.

### Other Operation Example 1 According to First Embodiment

In the first embodiment, an example in which the model transmission entity MTE is the gNB 200 has been described, but the model transmission entity MTE is not limited to the gNB 200. For example, the model transmission entity MTE may be a core network device. The core network device transmits a predetermined message including the model (step S502), but in this case, the core network device includes the deletion information in the model and transmits the model. When the UE 100 deletes the model, the UE 100 includes the deletion execution information in a predetermined message (the NAS message when the model transmission entity MTE is the AMF 300) and transmits the message to the core network device.

### Other Operation Example 2 According to First Embodiment

The model transmission entity MTE may be an over-the-top (OTT) server device. The OTT server device is, for example, a server device that is present outside the core network device and provides content service such as a messages, voice, or video. The OTT server device can transmit the model to the UE 100 using a predetermined signaling message. The OTT server device includes the deletion information in the model and transmits the message including the model to the UE 100 (step S502). When the UE 100 deletes the model, the UE 100 transmits a message including the deletion execution information to the OTT server device (step S505).

### Second Embodiment

Next, a second embodiment will be described. In the second embodiment, differences from the first embodiment will be mainly described.

In the first embodiment, an example in which the deletion information is included in the model and the model is transmitted so that the deletion information is transmitted has been described. In the second embodiment, an example in which the deletion information is transmitted by signaling, separately from the transfer of the model will be described.

Specifically, first, the model transmission entity (for example, the gNB 200) transmits the AI/ML model to the model reception entity (for example, the UE 100). Second, the model transmission entity transmits a message including the deletion prohibition information and/or the deletion condition information to the model reception entity.

Accordingly, for example, in the second embodiment, since the UE 100 can receive the deletion information, it is possible to delete the AI/ML model in accordance with the deletion information, as in the first embodiment. Therefore, the UE 100 will no longer delete the AI/ML model at its own discretion, and can delete the model in accordance with an instruction from the network side. Accordingly, the UE 100 can appropriately delete the AI/ML model.

### Example of Transmission of Deletion Information According to Second Embodiment

In the second embodiment, the deletion information can be transmitted to the model reception entity MRE not only from the model transmission entity MTE but also from other entities.

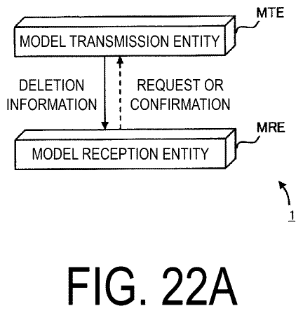

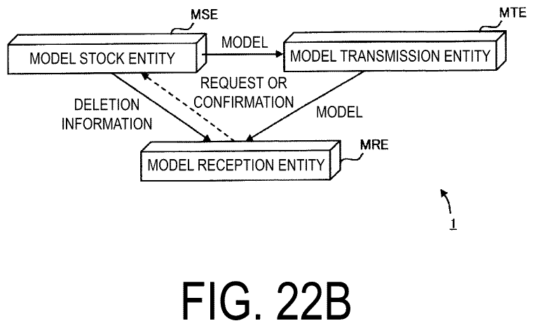

FIGS. 22A and 22B are diagrams illustrating a configuration example of a mobile communication system 1 according to the second embodiment. Of these, FIG. 22A illustrates an example in which the model transmission entity MTE transmits the deletion information to the model reception entity MRE, as in the first embodiment. In this case, the model reception entity MRE may transmit a request for the deletion information to the model transmission entity MTE. The model reception entity MRE may confirm with the model transmission entity MTE whether the deletion information has been transmitted. When the model reception entity MRE is the UE 100 and the model transmission entity MTE is the gNB 200, the request and the confirmation may be transmitted using a control message. Further, when the model reception entity MRE is the UE 100 and the model transmission entity MTE is a core network device (for example, the AMF 300), the request and the confirmation may be performed using a predetermined message (for example, an NAS message). The model transmission entity MTE may transmit the deletion information to the model reception entity MRE in response to the request or the confirmation. Thus, the transmission of the deletion information, the request, and the confirmation may be performed using signaling between the model transmission entity MTE and the model reception entity MRE.

FIG. 22B illustrates an example in which the model stock entity MSE transmits the deletion information to the model reception entity MRE. The model stock entity MSE is, for example, an entity that stocks the AI/ML model. The model stock entity MSE may store all of the AI/ML models in the mobile communication system 1. In FIG. 22B, when the model transmission entity MTE is the gNB 200, the model stock entity MSE may be a core network device. Alternatively, the model stock entity MSE may be an OTT server device.

The model transmission entity MTE acquires the model from the model stock entity MSE and transmits the model to the model reception entity MRE. The model transmission entity MTE may request the model stock entity MSE to acquire the model. The model stock entity MSE may transmit the model to the model transmission entity MTE in response to the request.

The model stock entity MSE transmits a predetermined message including the deletion information (the NAS message when the model stock entity MSE is the AMF 300) to the model reception entity MRE. The model reception entity MRE may request the model stock entity MSE to transmit the deletion information. The model reception entity MRE may confirm with the model stock entity MSE whether the deletion information has been transmitted. The request and the confirmation may also be performed using a predetermined message. The model stock entity MSE may transmit the deletion information to the model reception entity MRE in response to receiving the request or the confirmation.

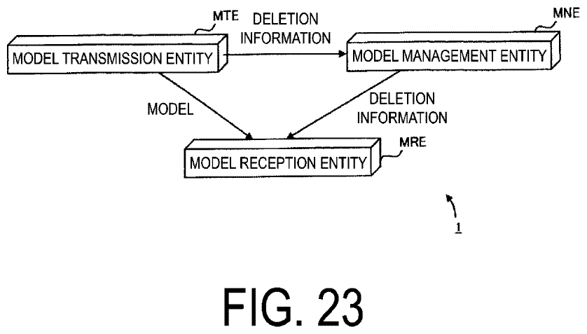

FIG. 23 is a diagram illustrating a configuration example of the mobile communication system 1 according to the second embodiment. FIG. 23 illustrates an example in which the model management entity MNE transmits the deletion information to the model reception entity MRE.

The model management entity MNE is, for example, an entity that manages the AI/ML model used in the mobile communication system 1. The model transmission entity MTE transmits the model to the model reception entity MRE and transmits the deletion information to the model management entity MNE. The model management entity MNE receives the deletion information and transmits the deletion information to the model reception entity MRE.

The model management entity MNE may also be a core network device. The model management entity MNE may also be an OTT server device. The model management entity MNE may transmit the deletion information by transmitting a predetermined message including the deletion information (an NAS message when the model management entity MNE is the AMF 300) to the model reception entity MRE. The model reception entity MRE may perform a request for transmission of the deletion information and confirmation of whether the deletion information has been transmitted, with respect to the model transmission entity MTE.

Operation Example According to Second Embodiment Next, an operation example according to the second embodiment will be described.

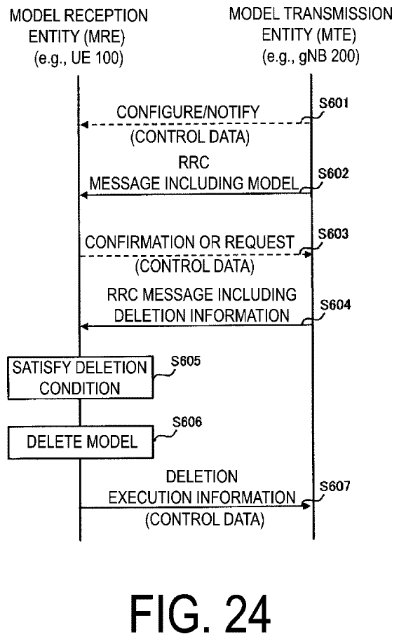

FIG. 24 is a diagram illustrating an operation example according to the second embodiment. As illustrated in FIG. 24, the operation example will be described using an example (FIG. 22A) in which the model transmission entity MTE is the gNB 200 and the model reception entity MRE is the UE 100.

Step S601 is the same as step S501 in the first embodiment.

In step S602, the gNB 200 transmits the RRC message including the model to the UE 100. In the second embodiment, the model does not include the deletion information.

In step S603, the UE 100 may request the gNB 200 to transmit the deletion information. In step S603, the UE 100 may confirm with the gNB 200 whether to transmit the deletion information. The UE 100 may perform the request and the confirmation using the control message. In this case, the UE 100 may transmit to the gNB 200 information for specifying whether to confirm transmission or non-transmission of the deletion information to which model. The information may be specified by a model ID, model name, or model identification information. The information may be included in the control message. In subsequent embodiments, transmission of the information for specifying whether to confirm transmission or non-transmission of the deletion information to which model is similarly performed when confirming transmission or non-transmission of the deletion information.

In step S604, the gNB 200 transmits an RRC message including the deletion information to the UE 100. In this case, the gNB 200 may transmit to the UE 100 information for specifying the model that is a deletion target. The information may be specified by a model ID, model name, or model identification information. The information may be included in the deletion information. In subsequent embodiments, when the deletion information is transmitted, information for specifying the model that is the deletion target is similarly transmitted.

In step S605, the UE 100 enters a state in which the deletion condition is satisfied. In this case, as in the first embodiment, the UE 100 may notify the gNB 200 that the deletion condition is satisfied (or that the deletion is desired). The content of the notification and a trigger for transmitting the notification may also be the same as in the first embodiment. As in the first embodiment, when the gNB 200 may receive the notification and accepts deletion of the model, the gNB 200 may transmit the model deletion command to the UE 100. The notification and the model deletion command may also be transmitted using the control data, as in the first embodiment.

In step S606, the UE 100 deletes the model received in step S602. When the deletion information includes the deletion prohibition information but not the deletion condition information, the UE 100 may delete the model in accordance with the deletion prohibition information, regardless of whether the deletion condition is satisfied.

In step S607, the UE 100 transmits the deletion execution information to the gNB 200.

### Other Operation Example 1 According to Second Embodiment

In the second embodiment, an example in which the gNB 200 transmits the RRC message including the deletion information to the UE 100 (step S604) has been described. For example, instead of the gNB 200 transmitting the RRC message to the UE 100 (step S604), the model stock entity MSE may transmit a predetermined message including the deletion information (the NAS message when the model stock entity MSE is the AMF 300) (FIG. 22B).

Alternatively, the model management entity MNE may transmit a predetermined message including the deletion information (the NAS message when the model management entity MNE is the AMF 300) (for example, a second message) (FIG. 23), instead of the gNB 200 transmitting the RRC message to the UE 100 (step S604). In this case, the model management entity MNE may transmit a predetermined message including the deletion information to the UE 100 in response to receiving the predetermined message including the deletion information received from the model transmission entity MTE (for example, an N11 message when the model management entity MNE is the AMF 300 and the model transmission entity MTE is the gNB 200) (for example, a first message).

### Other Operation Example 2 According to Second Embodiment

In the second embodiment, an example in which the UE 100 requests the gNB 200 to transmit the deletion information and confirms whether the deletion information has been transmitted has been described, but the present disclosure is not limited to this example. For example, the UE 100 may transmit the request and the confirmation to the model stock entity MSE (step S603). In this case, the UE 100 may perform the request or the confirmation using a message (the NAS message when the model stock entity MSE is the AMF 300).

### Other Operation Example 3 According to Second Embodiment

In the second embodiment, an example in which the model transmission entity MTE is the gNB 200 has been described, but the model transmission entity MTE is not limited to the gNB 200. For example, the model transmission entity MTE may be a core network device. The core network device transmits the message including the model (step S602) and transmits the predetermined message including the deletion information (step S602). When the UE 100 deletes the model, the UE 100 transmits a message including the deletion execution information to the core network device (step S607).

### Other Operation Example 4 According to Second Embodiment

The model transmission entity MTE may be an OTT server device. The OTT server device transmits the message including the model to the UE 100 (step S602) and transmits the message including the deletion information to the UE 100 (step S604). When the UE 100 deletes the model, the UE 100 transmits the message including the deletion execution information to the OTT server device (step S607).

### Third Embodiment

Next, a third embodiment will be described. The third embodiment will be described with differences from the first embodiment and the second embodiment focused on.

For example, when the UE 100 is configured to perform model deletion in accordance with the deletion information, the UE 100 can perform the model deletion using the methods described in the first and second embodiments.

However, when the UE 100 is not configured to perform the model deletion in accordance with the deletion information, like a UE conforming to Rel-17 specifications or a UE conforming to Rel-16 specifications, model inference may continue to be executed without deleting the model. For example, even when the gNB 200 transmits deletion prohibition information to the UE 100, the UE 100 may continue to execute the model inference without deleting the model. Alternatively, even when the gNB 200 transmits the deletion condition information to the UE 100, the UE 100 may continue to execute model inference without deleting the model even when the deletion condition is satisfied.

Therefore, in the third embodiment, an example in which the UE 100 transmits the deletion permission information indicating whether execution of model deletion is permitted to the gNB 200 when the deletion condition is satisfied, even when the UE 100 is not configured to perform the model deletion in accordance with the deletion information will be described.

Specifically, first, the model reception entity (for example, the gNB 200) receives the deletion prohibition information and the deletion condition information. Second, when the model reception entity executes the model inference using the AI/ML model without deleting the AI/ML model regardless of the deletion condition being satisfied, the model reception entity transmits the deletion permission information indicating whether deletion of the AI/ML model is permitted to the model transmission entity (for example, the gNB 200) together with or instead of the inference result data.

Accordingly, for example, the gNB 200 can ascertain that the UE 100 deletes the model based on the deletion permission information. Therefore, since the gNB 200 can ascertain the model deletion, the UE 100 can appropriately delete the model.

Operation Example According to Third Embodiment Next, an operation example according to the third embodiment will be described.

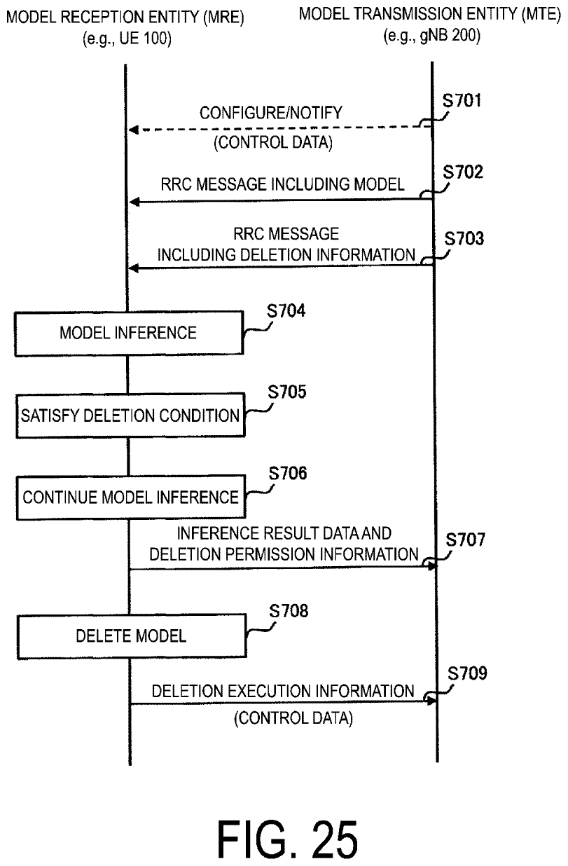

FIG. 25 is a diagram illustrating an operation example according to the third embodiment. As illustrated in FIG. 25, the operation example will be described using an example in which the model transmission entity MTE is the gNB 200 and the model reception entity MRE is the UE 100.

Step S701 is the same as step S601 in the second embodiment, step S702 is the same as step S602 in the second embodiment, and step S703 is the same as step S604 in the second embodiment. The UE 100 may confirm or request the deletion information (step S603), as in the second embodiment.

In step S704, the UE 100 performs model inference using the model (step S702).

In step S705, the UE 100 enters a state in which the deletion condition is satisfied.

In step S706, the UE 100 continues to execute the model inference regardless of the deletion condition being satisfied.

In step S707, the UE 100 transmits the deletion permission information to the gNB 200 together with the inference result data. For example, the controller 130 of the UE 100 compares the inference result data with the deletion condition, and transmits the deletion permission information when the inference result data satisfies the deletion condition (for example, when the inference result data is location information outside an “area” shown as the deletion conditions). Alternatively, when the model inferrer A3 outputs an error result instead of outputting the inference result data, the controller 130 may transmit the deletion permission information instead of the inference result data. The UE 100 may transmit the inference result data as user data and transmit the deletion permission information as the control data.

When the UE 100 transmits the deletion permission information, the UE 100 may also transmit cause information (Cause) indicating a reason for transmitting the deletion permission information to the gNB 200. The cause information may be, for example, that a “period” shown as the deletion condition has been exceeded, or that location information outside the “area” shown as the deletion condition has been acquired.

In step S708, the UE 100 deletes the model acquired in step S702.

In step S709, the UE 100 transmits the deletion execution information to the gNB 200.

### Other Operation Example 1 According to Third Embodiment

In the third embodiment, the model stock entity MSE may transmit the predetermined message including the deletion information (the NAS message when the model stock entity MSE is the AMF 300) (FIG. 22B) instead of the gNB 200 transmitting the RRC message including the deletion information to the UE 100 (step S703), as in the second embodiment. Alternatively, the model management entity MNE may transmit the predetermined message including the deletion information (the NAS message when the model management entity MNE is the AMF 300) (FIG. 23), instead of the gNB 200 transmitting the RRC message to the UE 100.

### Other Operation Example 2 According to Third Embodiment

In the third embodiment, the UE 100 may request the gNB 200 to transmit the deletion information or confirm whether the deletion information has been transmitted, as in the second embodiment. Alternatively, the UE 100 may transmit the request and the confirmation to the model stock entity MSE. In this case, the UE 100 may transmit a message including the request or the confirmation (or the NAS message when the model stock entity MSE is the AMF 300) to perform the request or the confirmation.

### Other Operation Example 3 According to Third Embodiment

In the third embodiment, the model transmission entity MTE may also be a core network device. The core network device transmits the message including the model (step S702) and transmits the predetermined message including the deletion information (step S703). When the UE 100 deletes the model, the UE 100 transmits a message including the deletion execution information to the core network device (step S709).

### Other Operation Example 4 According to Third Embodiment

In the third embodiment, the model transmission entity MTE may also be an OTT server device. The OTT server device transmits the message including the model to the UE 100 (step S702) and transmits the message including the deletion information to the UE 100 (step S703). When the UE 100 has deleted the model, the UE 100 transmits a message including the deletion execution information to the OTT server device (step S709).

### Fourth Embodiment

Next, a fourth embodiment will be described. In the fourth embodiment, differences from the first to third embodiments will be mainly described.

In the third embodiment, an example in which, when the UE 100 continues to perform model inference without deleting the model even when the deletion condition is satisfied, the UE 100 transmits the deletion permission information and then deletes the model has been described. In the fourth embodiment, an example in which, when the UE 100 continues to perform the model inference without deleting the model even when the deletion condition is satisfied, the model is automatically deleted without transmitting the deletion permission information will be described.

Specifically, first, the model reception entity (for example, the UE 100) receives the deletion prohibition information and the deletion condition information. Second, when the model reception entity has executed model inference using the AI/ML model regardless of the deletion condition being satisfied, the model reception entity deletes the AI/ML model.

Accordingly, for example, since the UE 100 can delete the model based on the deletion information received from the gNB 200, it is possible to delete the model in response to an instruction from the network side. Also, in the fourth embodiment, even the UE 100 with a specification that processing cannot be performed in accordance with the deletion information can delete the model, as in the third embodiment. Therefore, the UE 100 can appropriately delete the model.

In the fourth embodiment, there are two cases of model deletion including a first case in which the model itself is deleted and a second case in which t model data linked to the model is deleted.

In the first case, for example, the controller 130 may compare the inference result data (and/or inference data) from the model inferrer A3 with the deletion condition, and delete the model when the inference result data satisfies the deletion condition, as in the third embodiment. Alternatively, the controller 130 may delete the model when the model inferrer A3 outputs an error result instead of outputting the inference result data. Alternatively, the AI/ML model may delete its own model based on the inference result data from the model inferrer A3 and the deletion information, according to the same determination as in the controller 130.

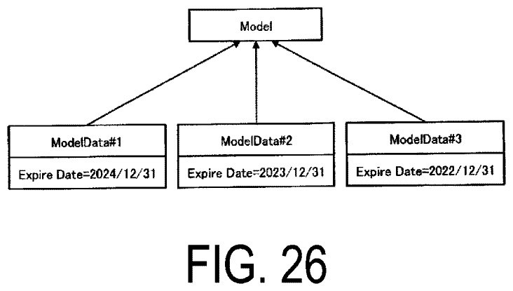

FIG. 26 is a diagram illustrating the second case. FIG. 26 shows an example of a relationship between the model and the model data according to the second embodiment. The model illustrated in FIG. 26 performs model training or performs model inference using any one of model data #1 to #3. Each of model data #1 to #3 has an expiration date. The expiration date may be included in the deletion condition. In other words, the deletion information may include a deletion condition that “model data #1 is permitted to be deleted after Jan. 1, 2025” (indicating “available until Dec. 31, 2024” as an expiration date), “model data #2 is permitted to be deleted after Jan. 1, 2024” (indicating “available until Dec. 31, 2023” as the expiration date), and “model data #3 is permitted to be deleted after Jan. 1, 2023” (indicating “available until Dec. 31, 2022” as the expiration date).

For example, in the UE 100, although the deletion condition is received from the gNB 200, when the model shown in FIG. 26 executes the model inference using model data #3, the control unit 130 may delete model data #3 stored in the memory of the UE 100, thereby allowing deletion of the model data.

Operation Example According to Fourth Embodiment Next, an operation example according to the fourth embodiment will be described.

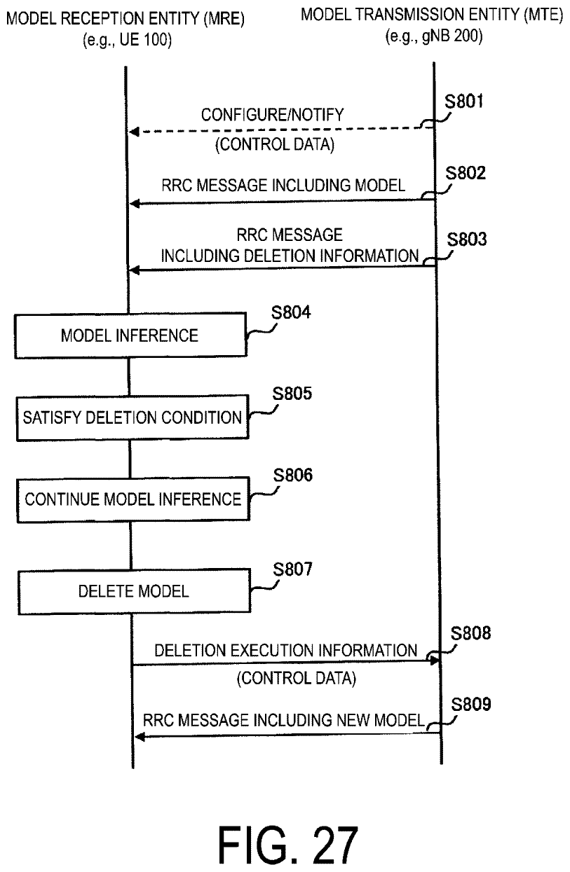

FIG. 27 is a diagram illustrating an operation example according to the fourth embodiment. The example illustrated in FIG. 27 illustrates an example in which the model transmission entity MTE is the gNB 200 and the model reception entity MRE is the UE 100, as in the third embodiment.

Steps S801 to S806 are the same as steps S701 to S706 (FIG. 25) of the third embodiment.

In step S807, the UE 100 deletes the model. As described above, the AI/ML model may delete its own model based on the inference result of the model inferrer A3 and the deletion information. The controller 130 may delete the model based on the inference result of the model inferrer A3 and the deletion information. Alternatively, the controller 130 may delete the model data satisfying the deletion condition.

In step S808, the UE 100 transmits the deletion execution information to the gNB 200.

In step S809, the UE 100 receives a new model from the gNB 200 and executes the next model inference (or model training) using the new model.

### Other Operation Example 1 According to Fourth Embodiment

In the fourth embodiment, the model stock entity MSE may transmit the predetermined message including the deletion information (the NAS message when the model stock entity MSE is the AMF 300) (FIG. 22B), instead of the gNB 200 transmitting the RRC message including the deletion information to the UE 100 (step S803), as in the third embodiment. Alternatively, the model management entity MNE may transmit a predetermined message including the deletion information (the NAS message when the model management entity MNE is the AMF 300) (for example, a second message) (FIG. 23), instead of the gNB 200 transmitting the RRC message to the UE 100.

### Other Operation Example 2 According to Fourth Embodiment

In the fourth embodiment, the UE 100 may request the gNB 200 to transmit the deletion information or confirm whether the deletion information has been transmitted, as in the second embodiment. Alternatively, the UE 100 may transmit the request and the confirmation to the model stock entity MSE. In this case, the UE 100 may perform the request or the confirmation using the message including the request or the confirmation (the NAS message when the model stock entity MSE is the AMF 300).

### Other Operation Example 3 According to Fourth Embodiment

In the fourth embodiment, the model transmission entity MTE may also be a core network device. The core network device transmits the message including the model (step S802) and transmits the predetermined message including the deletion information (step S803). When the UE 100 deletes the model, the UE 100 transmits the message including the deletion execution information to the core network device (step S808).

### Other Operation Example 4 According to Fourth Embodiment

The model transmission entity MTE may also be an OTT server device. The OTT server device transmits the message including the model to the UE 100 (step S802) and transmits the message including the deletion information to the UE 100 (step S803). When the UE 100 deletes the model, the UE 100 transmits the message including the deletion execution information to the OTT server device (step S809).

### OTHER EMBODIMENTS

For example, in the first embodiment described above, there may be a plurality of models that satisfy the deletion condition. In this case, the UE 100 may select any one of the plurality of models according to priority. The priority may be notified by the gNB 200 through broadcast signaling. The priority may be notified through individual signaling. The priority may be included in the control data and transmitted from the gNB 200. Similarly, in the second to fourth embodiments, the UE 100 can select any one of the plurality of models based on the priority.

Further, in the first to fourth embodiments described above, supervised learning has been mainly described, but the present disclosure is not limited thereto. For example, the first to fourth embodiments may be applied to unsupervised learning or reinforcement learning.

The above-described operation flows are not limited to being implemented independently, and may be implemented by a combination of two or more operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiments and examples, an example in which the base station is an NR base station (gNB) has been described, but the base station may also be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

In other words, the UE 100 may be a terminal function unit (a type of communication module) that allows the base station to control a relay that relays signals. Such terminal function unit is referred to as an MT. Examples of the MT include, a Network Controlled Repeater (NCR)-MT, a Reconfigurable Intelligent Surface (RIS)-MT, in addition to the IAB-MT.

Further, the term “network node” primarily refers to a base station, but may also refer to a core network device or a part (CU, DU, or RU) of the base station. The network node may include a combination of at least a part of the apparatus of the core network and at least a part of the base station.

A program that causes a computer to execute each process performed by the UE 100 or the gNB 200 may be provided. The program may be recorded on a computer-readable medium. Use of the computer-readable medium enables the program to be installed on a computer. Here, the computer-readable medium on which the program is recorded may be a non-transitory recording medium. The non-transitory recording medium is not particularly limited, but may be, for example, a recording medium such as a CD-ROM or a DVD-ROM. Further, a circuit that executes each process performed by UE 100 or gNB 200 may be integrated, and at least a portion of the UE 100 or the gNB 200 may be configured as a semiconductor integrated circuit (chipset or SoC: system on a chip).

Functions performed by the UE 100 or the gNB 200 (network node) may be implemented in circuitry or processing circuitry, including a general-purpose processor, an application-specific processor, an integrated circuit, an application specific integrated circuit (ASIC), a central processing unit (CPU), a circuit of the related art, and/or a combination thereof, which is programmed to perform the described functions. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The descriptions “based on” and “depending on/in response to” used in this disclosure do not mean “based only on” or “only in response to,” unless otherwise specified. The description “based on” means both “based only on” and “based at least partially on.” Similarly, the phrase “depending on” means both “only depending on” and “at least partially depending on”. The terms “include,” “comprise,” and variations thereof do not mean including only the listed items, but may mean including only the listed items or may include additional items in addition to the listed items. Also, the term “or” used in this disclosure is not intended to mean an exclusive OR. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

A program (e.g., information processing program) for causing a computer to execute each processing or each function according to the above-described embodiment may be provided. Alternatively, a program (for example, a mobile communication program) that causes the mobile communication system 1 to execute each process or function according to the above-described embodiments may be provided. The program may be recorded on a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

Although the embodiments have been described in detail above with reference to the drawings, specific configurations are not limited to those described above, and various design changes and the like can be made without departing from the gist. Further, it is also possible to combine the various embodiments, operation examples, or processes when there is no contradiction.

### Supplements

### Supplement 1

A communication control method in a mobile communication system, the communication control method including:
transmitting, by a model transmission entity to a model reception entity, deletion prohibition information indicating whether deletion of an AI/ML model is prohibited and/or deletion condition information indicating a deletion condition for the AI/ML model.

### Supplement 2

The communication control method according to supplement 1, wherein the transmitting includes transmitting, by the model transmission entity to the model reception entity, the AI/ML model including the deletion prohibition information and/or the deletion condition information.

### Supplement 3

The communication control method according to supplement 1 or 2, wherein the deletion prohibition information and/or the deletion condition information:
is contained in file data including the AI/ML model;
is added to a model ID identifying the AI/ML model; or
is contained in meta information of the AI/ML model.

### Supplement 4

The communication control method according to any one of supplements 1 to 3, wherein the transmitting includes the steps of:
transmitting, by the model transmission entity, the AI/ML model to the model reception entity; and
transmitting, by the model transmission entity to the model reception entity, a message including the deletion prohibition information and/or the deletion condition information.

### Supplement 5

The communication control method according to any one of supplements 1 to 4, further including:
transmitting, by a model stock entity configured to stock the AI/ML model, the message to the model reception entity instead of the transmitting of the message.

### Supplement 6

The communication control method according to any one of supplements 1 to 5, further including the steps of:
instead of the transmitting of the message,
transmitting, by the model transmission entity to a model management entity configured to manage the AI/ML model, a first message including the deletion prohibition information and/or the deletion condition information; and
transmitting, by the model management entity to the model reception entity, a second message including the deletion prohibition information and/or the deletion condition information.

### Supplement 7

The communication control method according to any one of supplements 1 to 6, further including:
transmitting, by the model reception entity to the model transmission entity, request information requesting transmission of the deletion prohibition information and/or the deletion condition information,
wherein the transmitting of the message includes transmitting, by the model transmission entity, the message to the model reception entity in response to receiving the request information.

### Supplement 8

The communication control method according to any one of supplements 1 to 7, further including:
transmitting, by the model reception entity to the model stock entity, request information requesting transmission of the deletion prohibition information and/or the deletion condition information,
wherein the transmitting of the message includes transmitting, by the model stock entity, the message to the model reception entity in response to receiving the request information.

### Supplement 9

The communication control method according to any one of supplements 1 to 8, further including the steps of:
deleting, by the model reception entity, the AI/ML model based on the deletion prohibition information and/or the deletion condition information; and
transmitting, by the model reception entity to the model transmission entity, deletion execution information indicating that the AI/ML model has been deleted.

### Supplement 10

The communication control method according to any one of supplements 1 to 9, further including the steps of:
receiving, by the model reception entity, the deletion prohibition information and the deletion condition information; and
transmitting, by the model reception entity to the model transmission entity, deletion permission information indicating whether deletion of the AI/ML model is permitted together with or instead of inference result data, when executing model inference using the AI/ML model without deleting the AI/ML model regardless of the deletion condition being satisfied.

### Supplement 11

The communication control method according to any one of supplements 1 to 10, further including:
deleting, by the model reception entity, the AI/ML model after transmitting the model deletion permission information.

### Supplement 12

The communication control method according to any one of supplements 1 to 11, further including the steps of:
receiving, by the model reception entity, the deletion prohibition information and the deletion condition information; and
deleting, by the model reception entity, the AI/ML model, when executing model inference using the AI/ML model regardless of the deletion condition being satisfied.

### Supplement 13

The communication control method according to any one of supplements 1 to 12, wherein the model transmission entity is one of a base station, a core network device, or an OTT server device, and the model reception entity is a user equipment.

### REFERENCE SIGNS

1: Mobile communication system
20: 5GC (CN)
100: UE
110: Receiver
120: Transmitter
130: Controller
200: gNB
210: Transmitter
220: Receiver
230: Controller
A1: Data collector
A2: Model trainer
A3: Model inferrer
A4: Data processor
TE: Transmission entity
RE: Reception entity
MTE: Model transmission entity
MRE: Model reception entity
MSE: Model stock entity
MNE: Model management entity

1. A communication control method in a mobile communication system, the communication control method comprising:
transmitting, by a model transmission entity to a model reception entity, deletion prohibition information indicating whether deletion of an artificial intelligence (AI)/machine learning (ML) model is prohibited and/or deletion condition information indicating a deletion condition for the AI/ML model.

2. The communication control method according to claim 1, wherein the transmitting comprises transmitting, by the model transmission entity to the model reception entity, the AI/ML model comprising the deletion prohibition information and/or the deletion condition information.

3. The communication control method according to claim 2, wherein the deletion prohibition information and/or the deletion condition information:
is contained in file data comprising the AI/ML model;
is added to a model ID identifying the AI/ML model; or
is contained in meta information of the AI/ML model.

4. The communication control method according to claim 1, wherein the transmitting comprises:
transmitting, by the model transmission entity, the AI/ML model to the model reception entity; and
transmitting, by the model transmission entity to the model reception entity, a message comprising the deletion prohibition information and/or the deletion condition information.

5. The communication control method according to claim 4, further comprising:
transmitting, by a model stock entity configured to stock the AI/ML model, the message to the model reception entity instead of the transmitting of the message.

6. The communication control method according to claim 4, further comprising:
instead of the transmitting of the message,
transmitting, by the model transmission entity to a model management entity configured to manage the AI/ML model, a first message comprising the deletion prohibition information and/or the deletion condition information; and
transmitting, by the model management entity to the model reception entity, a second message comprising the deletion prohibition information and/or the deletion condition information.

7. The communication control method according to claim 4, further comprising:
transmitting, by the model reception entity to the model transmission entity, request information requesting transmission of the deletion prohibition information and/or the deletion condition information,
wherein the transmitting of the message comprises transmitting, by the model transmission entity, the message to the model reception entity in response to receiving the request information.

8. The communication control method according to claim 5, further comprising:
transmitting, by the model reception entity to the model stock entity, request information requesting transmission of the deletion prohibition information and/or the deletion condition information,
wherein the transmitting of the message comprises transmitting, by the model stock entity, the message to the model reception entity in response to receiving the request information.

9. The communication control method according to claim 1, further comprising:
deleting, by the model reception entity, the AI/ML model based on the deletion prohibition information and/or the deletion condition information; and
transmitting, by the model reception entity to the model transmission entity, deletion execution information indicating that the AI/ML model has been deleted.

10. The communication control method according to claim 1, further comprising:
receiving, by the model reception entity, the deletion prohibition information and the deletion condition information; and
transmitting, by the model reception entity to the model transmission entity, deletion permission information indicating whether deletion of the AI/ML model is permitted together with or instead of inference result data, when executing model inference using the AI/ML model without deleting the AI/ML model regardless of the deletion condition being satisfied.

11. The communication control method according to claim 10, further comprising:
deleting, by the model reception entity, the AI/ML model after transmitting the model deletion permission information.

12. The communication control method according to claim 1, further comprising:
receiving, by the model reception entity, the deletion prohibition information and the deletion condition information; and
deleting, by the model reception entity, the AI/ML model, when executing model inference using the AI/ML model regardless of the deletion condition being satisfied.

13. The communication control method according to claim 1, wherein
the model transmission entity is one of a base station, a core network device, or an OTT server device, and
the model reception entity is a user equipment.

14. A model transmission entity, comprising:
a transmitter configured to transmit, to a model reception entity, deletion prohibition information indicating whether deletion of an artificial intelligence (AI)/machine learning (ML) model is prohibited and/or deletion condition information indicating a deletion condition for the AI/ML model.
